(19) United States
(12) Patent Application Publication
(10) Pub. No.: US 2004/0137119 A1
(43) Pub. Date: Jul. 15, 2004

(54) Lollipop with secret compartment for a novelty item

(76) Inventor: Marc Zak, Sonoma, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/341,628

(22) Filed: Jan. 14, 2003

(51) Int. Cl. A23G 1/00

(52) U.S. Cl. 426/134

(57) ABSTRACT

The present invention is directed to a lollipop having a first support structure portion that may include a first handle portion and a first housing portion coupled to an end of the first handle portion. The lollipop may further include a second support structure portion that may include a second handle portion that may be adapted to retentively engage the first handle portion, and a second housing portion coupled to an end of the second handle portion that may be adapted to retentively engage the first housing portion. The first housing portion and the second housing portion may define a hollow compartment when the second housing portion retentively engages the first housing portion. Still further, the lollipop may include a novelty item disposed within the hollow compartment defined by the first housing portion and the second housing portion, and a consumable product disposed on the outer surface of the hollow compartment defined by the first housing portion and the second housing portion.

### BACKGROUND

The patent is directed to a lollipop or other confectionery product on a support structure, and more particularly to a lollipop having a support structure with a secret compartment, such as a hollow spherical housing, disposed within a consumable product and being capable of holding a novelty item therein.

Various confectionery products capable of holding a novelty item have been previously described. For example, U.S. Pat. No. 5,302,403 to Cook et al. discloses a handle for a confectionery product that envelopes a housing detachably engaged to a support. The housing receives a novelty item. After the confectionery product is eaten, the novelty item is released by breaking the support from the housing.

U.S. Pat. No. 6,162,476 to Shorin discloses a novelty confectionery product having a prize that includes first and second separable components forming a container including a handle and a stalk, the stalk projecting from the handle. The stalk includes a leg projecting from each component, the legs being encompassed within a solid confectionery portion which precludes separation of the legs and, hence, of the components. One of the two legs includes an end or terminus disposed closer to the surface of the confectionery portion than the other leg. The user need only remove increments of the confection to expose the shorter leg, thereby enabling separation of the legs and opening of the container while the remainder of the confectionery portion remains mounted on the longer leg.

### SUMMARY OF THE INVENTION

In one aspect, the invention is directed to a support structure for supporting a consumable product. The support structure may include a first handle portion that may have a semi-circular cross-section and a plurality of fins extending from an inner surface of the first handle portion and that may be substantially linearly aligned along a longitudinal axis of the first handle portion. Each of the plurality of fins may be spaced from the adjacent fins such that each pair of adjacent fins defines a gap therebetween. The support structure may also include a second handle portion having a semi-circular cross-section and may include a plurality of pairs of ribs extending from an inner surface of the second handle portion, wherein the pairs of ribs may be substantially linearly aligned along a longitudinal axis of the second handle portion with each pair of ribs being spaced from each adjacent pair of ribs by a finger extending from the inner surface of the second handle portion. The fingers of the second handle portion may align with corresponding gaps of the first handle portion to substantially align the first and the second handle portions with the fins disposed between each pair of gaps being substantially aligned with the corresponding pair of ribs between the corresponding fingers. Each pair of ribs may be adapted to retentively engage the corresponding fin to demountably attach the second handle portion to the first handle portion.

The support structure may further include a first housing portion coupled to an end of the first handle portion, and may include an annular counterbore in an inner surface of the first housing portion disposed proximate an edge of the first housing portion. The annular counterbore may be tapered inwardly as the inner surface progresses inwardly from the edge of the first housing portion and may have an annular groove disposed in a portion of the inner surface of the annular counterbore. Still further, the support structure may include a second housing portion coupled to an end of the second handle portion and may include an annular flange extending outwardly from an edge of the second housing portion. The annular flange may be tapered inwardly as the annular flange extends outwardly from the edge of the second housing portion and may have an annular ring disposed on a portion of an outer surface of the annular flange. The annular groove of the first housing portion may be adapted to retentively engage the annular ring of the second housing portion when the annular flange is disposed within the annular counterbore of the first housing portion with the annular ring disposed within the annular groove to demountably attach the second housing portion to the first housing portion. The first housing portion and the second housing portion may define a hollow compartment when the second housing portion is demountably attached to the first housing portion.

In another aspect, the present invention is directed to a support structure for supporting a consumable product that may include a first support structure portion that may have a first handle portion and a first housing portion coupled to an end of the first handle portion. The support structure may also include a second support structure portion that may have a second handle portion that may be adapted to retentively engage the first handle portion and a second housing portion coupled to an end of the second handle portion that may be adapted to retentively engage the first housing portion. The first housing portion and the second housing portion may define a hollow compartment when the second housing portion retentively engages the first housing portion.

In a still further aspect, the present invention is directed to a lollipop having a first support structure portion that may include a first handle portion and a first housing portion coupled to an end of the first handle portion. The lollipop may further include a second support structure portion that may include a second handle portion that may be adapted to retentively engage the first handle portion, and a second housing portion coupled to an end of the second handle portion that may be adapted to retentively engage the first housing portion. The first housing portion and the second housing portion may define a hollow compartment when the second housing portion retentively engages the first housing portion. Still further, the lollipop may include a novelty item disposed within the hollow compartment defined by the first housing portion and the second housing portion, and a consumable product disposed on the outer surface of the hollow compartment defined by the first housing portion and the second housing portion.

In yet another aspect, the present invention is directed to a lollipop having a first support structure portion comprising a handle and a first housing portion coupled to an end of the handle. The lollipop may further include a second support structure portion that may include a second housing portion that may be adapted to retentively engage the first housing portion. The first housing portion and the second housing portion may define a hollow compartment when the second housing portion retentively engages the first housing portion. The lollipop may further include a novelty item disposed within the hollow compartment defined by the first housing portion and the second housing portion, and a consumable product that may be disposed on the outer surface of the hollow compartment defined by the first housing portion and the second housing portion.

Additional aspects of the invention are defined by the claims of this patent.

### BRIEF DESCRIPTION OF THE DRAWINGS

FIG. 1 is a perspective view of an embodiment of a lollipop having a secret compartment and a novelty item disposed therein;

FIG. 2 is a perspective view of the lollipop support structure of FIG. 1 with the housing portions and handle portions partially disengaged;

FIG. 3 is a perspective view of a first support structure portion of the lollipop support structure of FIG. 1;

FIG. 4 is a cross-sectional view taken along line 4-4 of FIG. 3;

FIG. 5 is a cross-sectional view taken along line 5-5 of FIG. 3;

FIG. 6 is a perspective view of a second support structure portion of the lollipop support structure of FIG. 1;

FIG. 7 is a cross-sectional view taken along line 7-7 of FIG. 6;

FIG. 8 is a cross-sectional view taken along line 8-8 of FIG. 6;

FIG. 9 is a cross-sectional view taken along line 9-9 of FIG. 1 with the consumable product and novelty item removed;

FIG. 10 is a cross-sectional view taken along line 10-10 of FIG. 1;

FIG. 11 is a side view of an alternative embodiment of the lollipop support structure of FIG. 1;

FIG. 12 is a side view of an alternative embodiment of a lollipop support structure;

FIG. 13 is a side view of another alternative embodiment of the lollipop support structure of FIG. 12; and

FIG. 14 is a side view of a further alternative embodiment of a lollipop support structure.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

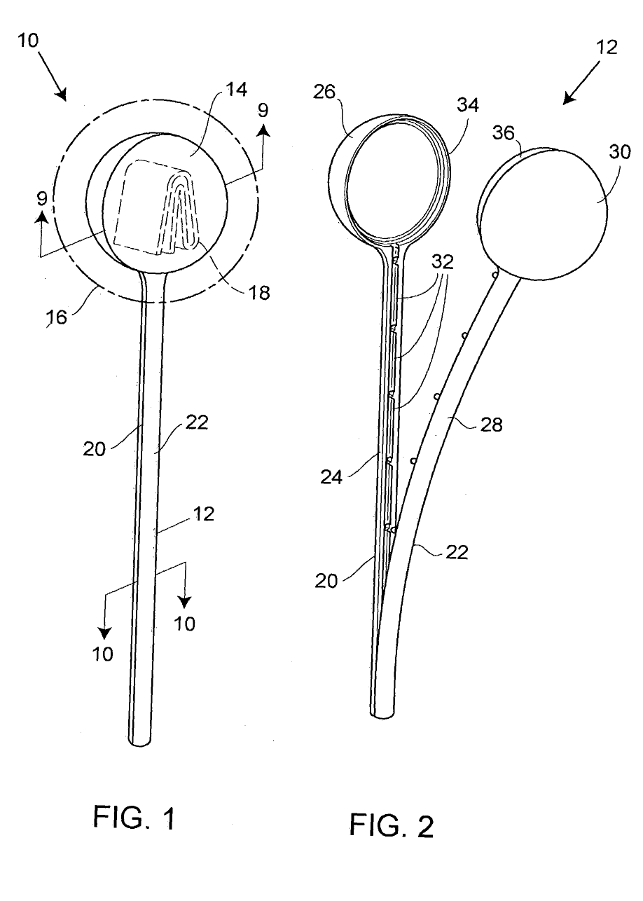

FIG. 1 illustrates one possible embodiment of a lollipop 10 having a support structure 12 with a hollow secret compartment 14 disposed at one end of the support structure 12, and having with a consumable product 16 disposed thereon. The consumable product 16 may be a confectionery product, such as a candy sucker, ice cream and the like, that may be formed on the exterior of the compartment 14. Prior to encasing the compartment 14 within the consumable product 16, a novelty item 18 may be disposed within the compartment 14. The novelty item 18 may be any item intended to be provided to the purchaser of the lollipop 10, such as an additional consumable product, such as a gum ball, candy or a confectionery powder, a toy or toys, figurines, paper products, such as notes, secret messages or stickers, and the like. Further, the compartment 14 of the support structure 12 may be wholly or partially fabricated from a translucent material so that the novelty item 18 may be visible from the exterior of the compartment 14.

The support structure 12 and compartment 14 may be divided into a first support structure portion 20 and a second support structure portion 22 that may be separable when the consumable product 16 is not disposed on the compartment 14 to allow the novelty item 18 to be placed within the compartment 14. Once the novelty item 18 is disposed within the portion of the compartment 14 defined by either the first or second support structure portion 20 or 22, the first support structure portion 20 and second support structure portion 22, which may be adapted to retentively engage each other to form the support structure 12, may be connected with the hollow compartment 14 enclosing the novelty item 18. Once the first support structure portion 20 and the second support structure portion 22 are connected to form the support structure 12, the consumable product 16 may be deposited on the exterior of the compartment 14 to seal the compartment 14 and the novelty item 18 therein. In order to retrieve the novelty item 18 from the compartment 14, the consumable product 16 is eaten or otherwise removed from the exterior of the compartment 14, thereby allowing the first and second support structure portions 20, 22 to be disengaged and separated to permit access to the compartment 14 for removal of the novelty item 18.

Referring to FIG. 2, the support structure 12 is illustrated with the second support structure portion 22 partially separated from the first support structure portion 20. The first support structure portion 20 may include a first handle portion 24, which may be configured as an elongated stick, having a first housing portion 26 attached at one end of the first handle portion 24. As illustrated herein, the first handle portion 24 and first housing portion 26 may be integrally formed as a unitary component to construct the first support structure portion 20. However, the first handle portion 24 and the first housing portion 26 may alternatively be formed as separate components, with the first housing portion 26 then being connected to the end of the first handle portion 24 to form the first support structure portion 20. Similarly, the second support structure portion 22 may include a second handle portion 28, which may also be configured as an elongated stick, having a second housing portion 30 disposed at one end of the second handle portion 28. As with the first support structure portion 20, the second handle portion 28 and second housing portion 30 may be integrally formed as a unitary component or formed separately and then connected to form the second support structure portion 22. Regardless of the manner in which the first and second housing portions 26, 30 are connected to the first and second handle portions 24, 28, the housing portions 26, 30 may be permanently connected to the first and second handle portions 24, 28 and dimensioned sufficiently large to satisfy regulatory requirements directed to prevent choking hazards.

The first support structure portion 20 and second support structure portion 22 may be constructed such that the first handle portion 24 engages the second handle portion 28, and the first housing portion 26 engages the second housing portion 30 to form the support structure 12 and hollow compartment 14. In one embodiment, the first handle portion 24 may include one or more fins 32 extending from an inner surface of the first handle portion 24 and mating with corresponding connection structures extending from an inner surface of the second handle portion 28. Additionally, the first housing portion 26 may include an annular counterbore 34 in the inner surface of the first housing portion 26 that may be engaged by an annular flange 36 of the second housing portion 30 to connect the first and second housing portions 26, 30 and form the hollow compartment 14.

While the compartment 14 is illustrated herein as having a spherical shape formed from symmetrical hemispherical housing portions 26 and 30, those skilled in the art will understand that the compartment 14 may be configured in any geometric shape capable of enclosing a particular novelty item 18. For example, the compartment 14 may be cubic, rectangular, triangular, pyramid-shaped, conical, cylindrical, oblong, or any other appropriate shape. Furthermore, the compartment 14 may be configured in a shape other than a geometric shape, such as in the shape of a character or other real or imaginary object. Moreover, regardless of whether the compartment 14 is configured in a geometric shape or other shape, the housing portions 26 and 30 forming the compartment 14 need not be symmetrical or mirror images of each other.

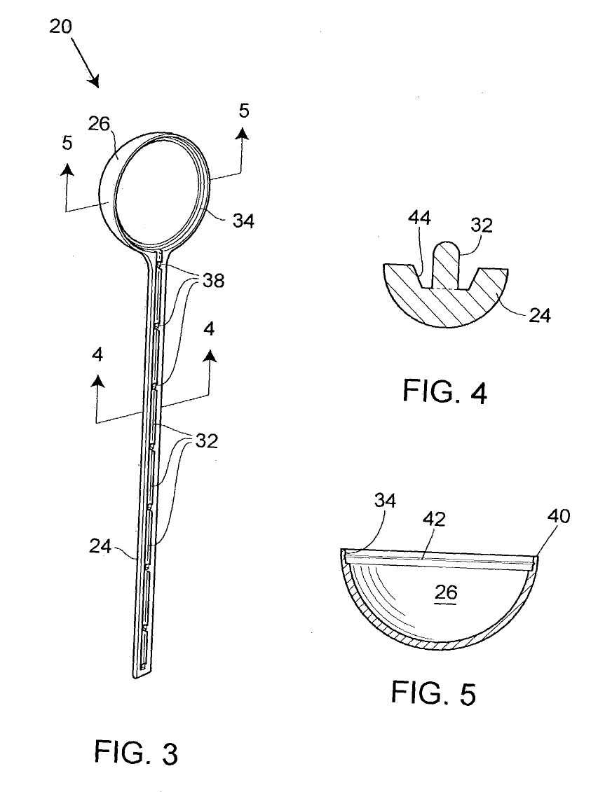

Referring now to FIGS. 3-5, an embodiment of the first support structure portion 20 is illustrated. As shown in FIG. 3, the first handle portion 24 and the first housing portion 26 may be integrally formed as a single component to form the first support structure portion 20. The fins 32 extend from the inner surface of the first handle portion 24, and may be substantially linearly aligned along a longitudinal axis of the first handle portion 24. Adjacent fins 32 may be spaced to define gaps 38 that may receive corresponding alignment elements of the second handle portion 28 in a manner more fully described below.

The cross-section of the embodiment of the first handle portion 24 is illustrated in FIG. 4. The first handle portion 24 may have an approximately semi-circular cross section with an inner surface 44 defining a channel extending longitudinally between the ends of the first handle portion 24. The fin 32 extends outwardly from the inner surface 44 of the first handle portion 24 and may be engageable by corresponding connection elements of the second handle portion 28.

As previously discussed, the first housing portion 26 includes an annular counterbore 34 that is engaged by a corresponding annular flange 36 of the second housing portion 30. As shown in FIG. 5, the annular counterbore 34 may be disposed at an edge 40 of the first housing portion 26, and taper inwardly from the edge 40 toward the closed end of the first housing portion 26. The annular counterbore 34 may further include an annular groove 42 defining a channel in the inner surface of the annular counterbore 34. The annular counterbore 34 and annular groove 42 may be engaged by the annular flange 36 to connect the housing portions 26, 30 in the manner more fully described below.

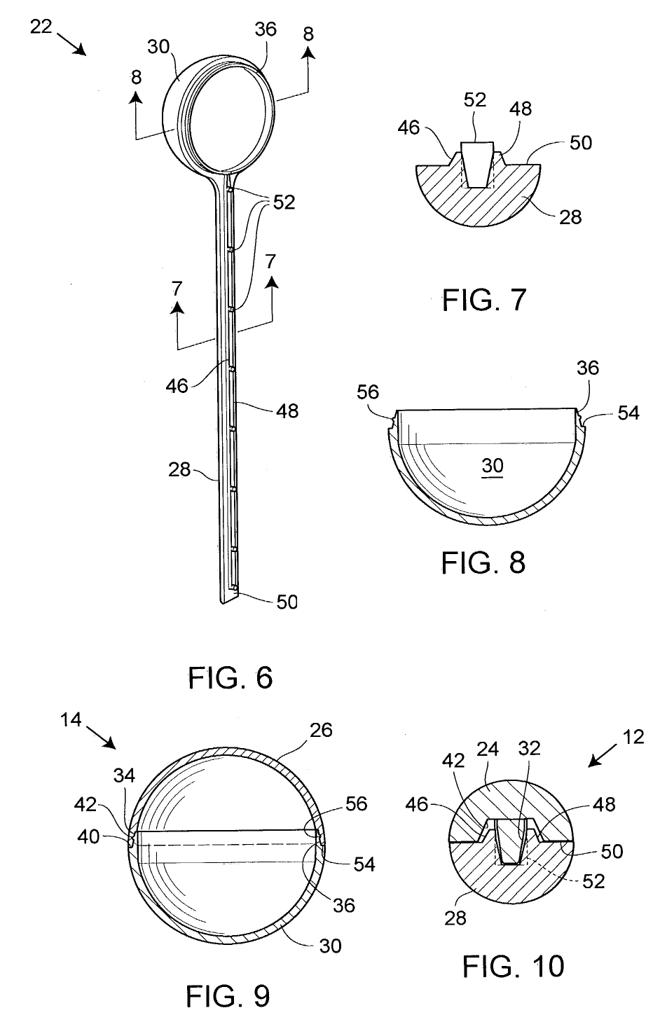

An embodiment of the second support structure portion 22 is illustrated in FIGS. 6-8. As with the first support structure portion 20, the second support structure portion 22 may be constructed by integrally forming the second handle portion 28 and second housing portion 30 as a single unitary component. The second handle portion 28 may include a pair of substantially parallel ribs 46, 48 extending outwardly from a surface 50 of the second handle portion 28. The ribs 46, 48 may be spaced apart and configured to receive and engage the fins 32 of the first handle portion 24 to retentively connect the first handle portion 24 to the second handle portion 28. The second handle portion 28 may further include a plurality of fingers 52 extending outwardly from the surface 50 and disposed between the ribs 46, 48, thereby defining a plurality of pairs of ribs 46, 48 that may be substantially linearly aligned along a longitudinal axis of the second handle portion 28. The fingers 52 may be positioned to be aligned with and received by the gaps 38 defined by the fins 32 of the first handle portion 24 when the first support structure portion 20 is connected to the second support structure portion 22. The fingers 52 and gaps 38 may thereby facilitate aligning the first and second housing portions 26, 30 and forming the hollow compartment 14.

As previously discussed, the second housing portion 30 may include an annular flange 36 adapted to engage the annular counterbore 34 of the first housing portion 26. Referring to FIG. 8, the annular flange 36 may extend outwardly from an edge 54 of the second housing portion 30. The flange 36 may taper inwardly as it extends from the edge 54, and may include an annular ring 56 extending outwardly from an outer surface of the annular flange 36.

The annular ring 56 may be positioned and adapted to be received by the annular groove 42 of the annular counterbore 34 of the first housing portion 26 to retentively connect the first and second housing portions 26, 30. As illustrated in FIG. 9, the first and second housing portions 26, 30 may be connected to form the hollow compartment 14. The flange 36 of the second housing portion 30 may be inserted into the annular counterbore 34 of the first housing portion 26 until the annular ring 56 is disposed within the grove 42, thereby connecting and sealing the first and second housing portions 26, 30. As previously discussed, the annular counterbore 34 and the annular flange 36 are tapered, which facilitates insertion of the annular flange 36 into the annular counterbore 34. The annular groove 42 and the annular ring 56 may be dimensioned so that the outer diameter of the annular ring 56 is larger than the inner diameter of the leading edge of the annular groove 42, with the first housing portion 26 and/or the second housing portion 30 being fabricated from a resilient material, such as polyethylene or other type of plastic, such that the annular ring 56 may be pushed passed the leading edge of the annular groove 42 and retained within the annular groove 42 until a force is applied to separate the first housing portion 26 from the second housing portion 30.

Referring now to FIG. 10, the first handle portion 24 is illustrated being retentively engaged by the second handle portion 28. Once the fingers 52 of the second handle portion 28 are aligned with the gaps 38 of the first handle portion 24, the fins 32 may be inserted between the corresponding ribs 46, 48 until the first handle portion 24 engages the surface 50 of the second handle portion 28. The fins 32 may be dimensioned so that the width of at least a portion of the fins 32 is larger than the space between the corresponding portions of the ribs 46, 48 when the fins 32 are fully or partially inserted between the ribs 46, 48. The first handle portion 24 and/or the second handle portion 28 may be fabricated from a resilient material, such as polyethylene or other type of plastic, such that the fins 32 may be fully inserted between the ribs 46, 48, with the ribs 46, 48 engaging the fins 32 to retentively connect the first and second handle portions 24, 28 until a force is applied to separate the first and second handle portion 24, 28.

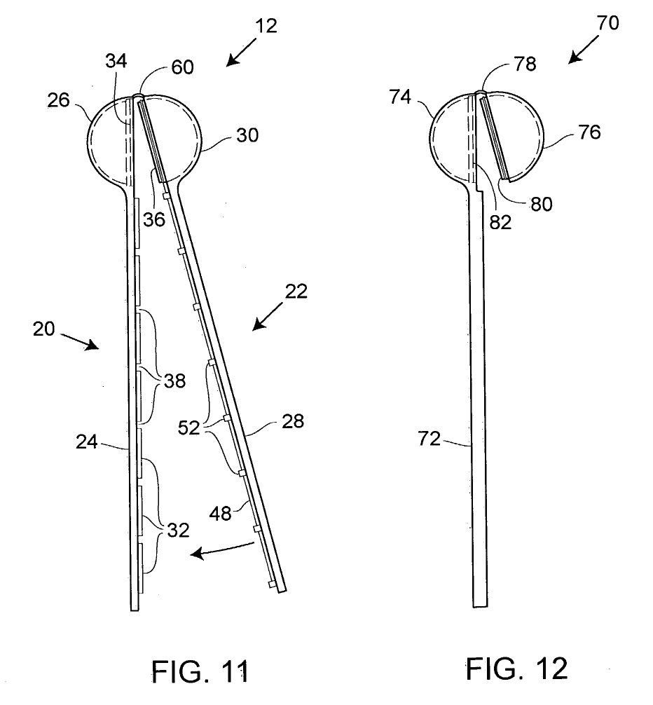

FIG. 11 illustrates an alternative embodiment of the support structure 12 wherein the first support structure portion 20 and second support structure portion 22 may be connected by a hinge 60. The hinge 60 may be a living hinge integrally formed with the first and second support structure portions 20, 22 to form the support structure 12 as a single component, with the first and second support structure portions 20, 22 being moveable with respect to each other between a disengaged position wherein the first and second support structure portions 20, 22 are separated, and an engaged portion wherein the first and second handle portions 24, 28 are connected by the fins 32 and ribs 46, 48, and the first and second housing portions 26, 30 are connected by the annular counterbore 34 and annular flange 36. Alternatively, the first and second support structure portions 20, 22 may be formed individually and later connected by attaching the hinge 60 to the ends of the first and second housing portions 26, 30 opposite the first and second handle portions 24, 28 to allow relative movement of the first and second support structure portions 20, 22. However, the hinge 60 may be disposed at any position on the first and second housing portions 26, 30, or any position along the first and second handle portions 24, 28, that may allow the first and second support structure portions 20, 22 to move between the engaged and disengaged positions. Further, while the hinge 60 is illustrated as a living hinge, the hinge 60 may be any type of connection mechanism that allows or facilitates movement of the first and second support structure portions 20, 22 between the engaged and disengaged positions through any type of path, such as circular, linear, curvilinear, indeterminate and the like.

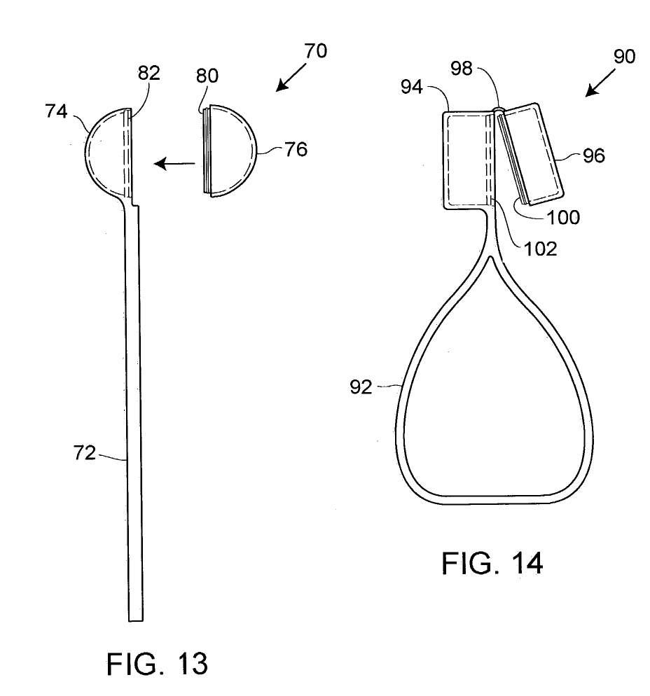

In a further alternative embodiment shown in FIG. 12, a support structure 70 for a lollipop may include a handle 72 integrally formed with a first housing portion 74 disposed at one end of the handle 72. The support structure 70 may further include a second housing portion 74 that may be connected to the first housing portion 72 by a hinge 78, which may be similar to the hinge 60 described above, adapted to allow or facilitate movement of the second housing portion 76 between a disengaged position and an engaged position wherein an annular flange 80 of the second housing portion 76 engages an annular counterbore 82 of the first housing portion 74 to form a hollow compartment. Alternative, as shown in FIG. 13, the second housing portion 76 may be a separate component from the first housing portion 74. In this embodiment, however, it may be necessary for the first and second housing portions 72, 74 to be dimensioned sufficiently large so that the second housing portion 74 does not present a choking hazard when detached from the first housing portion 72.

A still further embodiment of a support structure 90 for a lollipop is illustrated in FIG. 14. The support structure 90 may include a handle 92 integrally connected to a first housing portion 94 disposed at one end of the handle 92. The support structure 90 may further include a second housing portion 94 that may be connected to the first housing portion 92 by a hinge 98, which may be similar to the hinges 60 and 80 described above. The hinge 98 may be adapted to allow or facilitate movement of the second housing portion 96 between a disengaged position and an engaged position wherein an annular flange 100 of the second housing portion 96 engages an annular counterbore 102 of the first housing portion 94 to form a hollow compartment. The handle 92 may be configured in the shape of a loop so that one or more fingers of an individual may be inserted into the handle 92. The handle 92 may be integrally formed with the first housing portion 94 and be fabricated from the same material, or may be fabricated separately from the first housing portion 94 from the same material or a different material, such as paper, cardboard, cord or any other material that may be formed into a structure that may be grasped, and connected to the first housing portion 94 when the support structure 90 is manufactured. Additionally, the handle 92 may be formed from two or more connectable components, similar to the first and second handle portions 24, 28 of the support structure 12, and one of the components may be connected to and moveable with the second housing portion 96. Moreover, as illustrated in FIG. 14, the first and second housing portions 94, 96 may be asymmetrical and still be connected to define a hollow compartment. Moreover, the hollow compartment defined by the first and second housing portions 94, 96 may have a non-spherical shape, such as square or rectangular.

What is claimed is:

1. A support structure for supporting a consumable product, the support structure comprising:
a first handle portion having a semi-circular cross-section and including a plurality of fins extending from an inner surface of the first handle portion and substantially linearly aligned along a longitudinal axis of the first handle portion with each of the plurality of fins being spaced from the adjacent fins such that each pair of adjacent fins defines a gap therebetween;
a second handle portion having a semi-circular cross-section and including a plurality of pairs of ribs extending from an inner surface of the second handle portion, wherein the pairs of ribs are substantially linearly aligned along a longitudinal axis of the second handle portion with each pair of ribs being spaced from each adjacent pair of ribs by a finger extending from the inner surface of the second handle portion, wherein the fingers of the second handle portion align with corresponding gaps of the first handle portion to substantially align the first and the second handle portions with the fins disposed between each pair of gaps being substantially aligned with the corresponding pair of ribs between the corresponding fingers, each pair of ribs being adapted to retentively engage the corresponding fin to demountably attach the second handle portion to the first handle portion;
a first housing portion coupled to an end of the first handle portion and including an annular counterbore in an inner surface of the first housing portion and disposed proximate an edge of the first housing portion, the annular counterbore being tapered inwardly as the inner surface progresses inwardly from the edge of the first housing portion and having an annular groove disposed in a portion of the inner surface of the annular counterbore; and
a second housing portion coupled to an end of the second handle portion and including an annular flange extending outwardly from an edge of the second housing portion, the annular flange being tapered inwardly as the annular flange extends outwardly from the edge of the second housing portion and having a annular ring disposed on a portion of an outer surface of the annular flange, the annular groove of the first housing portion being adapted to retentively engage the annular ring of the second housing portion when the annular flange is disposed within the annular counterbore of the first housing portion with the annular ring disposed within the annular groove to demountably attach the second housing portion to the first housing portion, and wherein the first housing portion and the second housing portion define a hollow compartment when the second housing portion is demountably attached to the first housing portion.

2. A support structure as defined in claim 1, wherein the first housing portion has a hemispherical shape and the second housing portion has a hemispherical shape, and wherein the first housing portion and the second housing portion define a hollow sphere when the second housing portion is demountably attached to the first housing portion.

3. A support structure as defined in claim 1, wherein at least one of the first housing portion and the second housing portion is fabricated from a translucent material.

4. A support structure as defined in claim 1, wherein at least one of the first housing portion and the second housing portion is fabricated from a resilient material.

5. A support structure as defined in claim 1, wherein the first handle portion and the first housing portion are integrally formed as a single unitary component, and the second handle portion and the second housing portion are integrally formatted as a single unitary component.

6. A support structure as defined in claim 1, wherein the first handle portion, the second handle portion, the first housing portion and the second housing portion are adapted so that the annular counterbore of the first housing portion is substantially aligned with the annular flange of the second housing portion when the fingers of the second handle portion are aligned with corresponding gaps of the first handle portion.

7. A support structure as defined in claim 1, wherein the first housing portion is coupled to the second housing portion such that the first housing portion and second housing portion are adapted to move relative to each other between an engaged position wherein the second housing portion is demountable attached to the first housing portion, and a disengaged position wherein the second housing portion is detached from the first housing portion.

8. A support structure for supporting a consumable product, the support structure comprising:
a first support structure portion comprising:
a first handle portion, and
a first housing portion coupled to an end of the first handle portion;
a second support structure portion comprising:
a second handle portion being adapted to retentively engage the first handle portion, and
a second housing portion coupled to an end of the second handle portion and being adapted to retentively engage the first housing portion;
wherein the first housing portion and the second housing portion define a hollow compartment when the second housing portion retentively engages the first housing portion.

9. A support structure as defined in claim 8, wherein the first housing portion has a hemispherical shape and the second housing portion has a hemispherical shape, and wherein the first housing portion and the second housing portion define a hollow sphere when the second housing portion retentively engages the first housing portion.

10. A support structure as defined in claim 8, wherein the first handle portion comprises a first engagement member and the second handle portion comprises a pair of second engagement members, and wherein the pair of second engagement members engage the first engagement member to retentively engage the second handle portion to the first handle portion.

11. A support structure as defined in claim 8, wherein the first handle portion has a semi-circular cross-section and comprises a fin extending from an inner surface of the first handle portion, wherein the second handle portion has a semi-circular cross-section and comprises a pair of ribs extending from an inner surface of the second handle portion, and wherein the pair of ribs engages the fin to retentively engage the second handle portion to the first handle portion.

12. A support structure as defined in claim 11, wherein the first handle portion comprises a plurality of fins aligned along a longitudinal axis of the first handle portion, and the second handle portion comprises a plurality of pairs of parallel ribs aligned along a longitudinal axis of the second handle portion, and wherein each pair of parallel ribs corresponds to one of the ribs of the first handle portion and is adapted to engage the corresponding one of the ribs to retentively engage the second handle portion to the first handle portion.

13. A support structure as defined in claim 12, wherein each of the plurality of fins are spaced from the adjacent fins such that each pair of adjacent fins defines a gap therebetween, wherein each pair of parallel ribs is spaced from each adjacent pair of parallel ribs by a finger extending from the inner surface of the second handle portion, and wherein the fingers of the second handle portion align with corresponding gaps of the first handle portion to substantially align the first and the second handle portions with the fins disposed between each pair of gaps being substantially aligned with the corresponding pair of parallel ribs between the corresponding fingers.

14. A support structure as defined in claim 8, wherein the first housing portion comprises an annular counterbore and the second housing portion comprises an annular flange being adapted to be inserted into and retentively engaged by the annular counterbore to retentively engage the second housing portion to the first housing portion.

15. A support structure as defined in claim 14, wherein the first housing portion further comprises an annular groove disposed in an inner surface of the annular counter bore and the second housing further comprises an annular ring disposed on an outer surface of the annular flange, the annular groove being adapted to retentively engage the annular ring when the annular flange is disposed within the annular counterbore of the first housing portion with the annular ring disposed within the annular groove to demountably attach the second housing portion to the first housing portion.

16. A support structure as defined in claim 8, wherein at least one of the first housing portion and the second housing portion is fabricated from a translucent material.

17. A support structure as defined in claim 8, wherein the first handle portion and the first housing portion are integrally formed as a single unitary component, and the second handle portion and the second housing portion are integrally formed as a single unitary component.

18. A support structure as defined in claim 8, wherein the first housing portion is coupled to the second housing portion such that the first housing portion and second housing portion are adapted to move relative to each other between an engaged position wherein the second housing portion is demountable attached to the first housing portion, and a disengaged position wherein the second housing portion is detached from the first housing portion.

19. A lollipop comprising:
a first support structure portion comprising a first handle portion and a first housing portion coupled to an end of the first handle portion;
a second support structure portion comprising a second handle portion being adapted to retentively engage the first handle portion, and a second housing portion coupled to an end of the second handle portion and being adapted to retentively engage the first housing portion, wherein the first housing portion and the second housing portion define a hollow compartment when the second housing portion retentively engages the first housing portion;
a novelty item disposed within the hollow compartment defined by the first housing portion and the second housing portion; and
a consumable product disposed on the outer surface of the hollow compartment defined by the first housing portion and the second housing portion.

20. A lollipop as defined in claim 19, wherein the first housing portion has a hemispherical shape and the second housing portion has a hemispherical shape, and wherein the first housing portion and the second housing portion define a hollow sphere when the second housing portion retentively engages the first housing portion.

21. A lollipop as defined in claim 19, wherein the first handle portion comprises a first engagement member and the second handle portion comprises a pair of second engagement members, and wherein the pair of second engagement members engage the first engagement member to retentively engage the second handle portion to the first handle portion.

22. A lollipop as defined in claim 19, wherein the first handle portion has a semi-circular cross-section and comprises a fin extending from an inner surface of the first handle portion, wherein the second handle portion has a semi-circular cross-section and comprises a pair of ribs extending from an inner surface of the second handle portion, and wherein the pair of ribs engages the fin to retentively engage the second handle portion to the first handle portion.

23. A lollipop as defined in claim 22, wherein the first handle portion comprises a plurality of fins aligned along a longitudinal axis of the first handle portion, and the second handle portion comprises a plurality of pairs of parallel ribs aligned along a longitudinal axis of the second handle portion, and wherein each pair of parallel ribs corresponds to one of the ribs of the first handle portion and is adapted to engage the corresponding one of the ribs to retentively engage the second handle portion to the first handle portion.

24. A lollipop as defined in claim 23, wherein each of the plurality of fins are spaced from the adjacent fins such that each pair of adjacent fins defines a gap therebetween, wherein each pair of parallel ribs is spaced from each adjacent pair of parallel ribs by a finger extending from the inner surface of the second handle portion, and wherein the fingers of the second handle portion align with corresponding gaps of the first handle portion to substantially align the first and the second handle portions with the fins disposed between each pair of gaps being substantially aligned with the corresponding pair of parallel ribs between the corresponding fingers.

25. A lollipop as defined in claim 19, wherein the first housing portion comprises an annular counterbore and the second housing portion comprises an annular flange being adapted to be inserted into and retentively engaged by the annular counterbore to retentively engage the second housing portion to the first housing portion.

26. A lollipop as defined in claim 24, wherein the first housing portion further comprises an annular groove disposed in an inner surface of the annular counter bore and the second housing further comprises an annular ring disposed on an outer surface of the annular flange, the annular groove being adapted to retentively engage the annular ring when the annular flange is disposed within the annular counterbore of the first housing portion with the annular ring disposed within the annular groove to demountably attach the second housing portion to the first housing portion.

27. A lollipop as defined in claim 19, wherein at least one of the first housing portion and the second housing portion is fabricated from a translucent material.

28. A lollipop as defined in claim 19, wherein the first handle portion and the first housing portion are integrally formed as a single unitary component, and the second handle portion and the second housing portion are integrally formed as a single unitary component.

29. A lollipop as defined in claim 19, wherein the consumable product is selected from the group consisting of candy and ice cream.

30. A lollipop as defined in claim 19, wherein the novelty item is selected from the group consisting of paper, candy, toy, figurine and consumable powder.

31. A lollipop as defined in claim 19, wherein the first housing portion is coupled to the second housing portion such that the first housing portion and second housing portion are adapted to move relative to each other between an engaged position wherein the second housing portion is demountable attached to the first housing portion, and a disengaged position wherein the second housing portion is detached from the first housing portion.

32. A lollipop comprising:
a first support structure portion comprising a handle and a first housing portion coupled to an end of the handle;
a second support structure portion comprising a second housing portion being adapted to retentively engage the first housing portion, wherein the first housing portion and the second housing portion define a hollow compartment when the second housing portion retentively engages the first housing portion;
a novelty item disposed within the hollow compartment defined by the first housing portion and the second housing portion; and
a consumable product disposed on the outer surface of the hollow compartment defined by the first housing portion and the second housing portion.

33. A lollipop as defined in claim 32, wherein the handle comprises a first handle portion having the first housing portion coupled to an end thereof and a second handle portion being adapted to retentively engage the first handle portion, the second handle portion having the second housing portion coupled to an end thereof.

34. A lollipop as defined in claim 32, wherein the first housing portion is coupled to the second housing portion such that the first housing portion and second housing portion are adapted to move relative to each other between an engaged position wherein the second housing portion is demountable attached to the first housing portion, and a disengaged position wherein the second housing portion is detached from the first housing portion.
